(19) United States
(12) Patent Application Publication
(10) Pub. No.: US 2003/0126957 A1
(43) Pub. Date: Jul. 10, 2003

(54) Socket wrench

(76) Inventor: Hsiu-Ching Huang, Taipei (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/073,627

(22) Filed: Feb. 11, 2002

(30) Foreign Application Priority Data
Jan. 4, 2002 (TW) 91200092

(51) Int. Cl. B25B 13/46

(52) U.S. Cl. 81/60

(57) ABSTRACT

A socket wrench includes a spanner and a joint. The spanner includes an elongated body, an annular head, a driving element received in the annular head and a ratchet mechanism arranged between the annular head and the driving element. Thus, a one-way rotation of the driving element can be selectively provided while the spanner is swayed. The driving element defines a hole. The joint includes a middle section, a first terminal section and a second terminal section including a size different from that of the first terminal section. The middle section is used for insertion in the hole, the first terminal section is used for engagement with a socket of a first series while the second terminal section being used for engagement with a socket of a second series.

### BACKGROUND OF INVENTION

1. Field of Invention

The present invention is related to a socket wrench and, more particularly, to a socket wrench including a joint for engagement with two series of sockets.

2. Related Prior Art

Today, a lot of household stuffs, furniture, machines, tools, and etc. include a number of components assembled by means of bolts and nuts. For engagement or disengagement of such components, they are often driven by means of wrenches (or “spanner”). Therefore, mechanics keep a lot of sockets at work. People have gotten used to the idea of keeping wrenches at home.

A wrench includes an elongated body and two enlarged heads each defining an opening or hexagonal hole for engagement with a head of a bolt. Each head of a wench is used to drive only a bolt of a specific size.

Two conventional types of socket wrenches have been devised. In one type, socket wrenches all include an elongated body and two sockets each for engagement with a head of a bolt. Each socket is used to drive only a bolt of a specific size. In the other type, a spanner connected with one of sockets of various sizes via a joint.

FIG. 7 shows a conventional socket wrench including a spanner 4, a socket 6 and a joint 1 for connecting the spanner 4 with the socket 6. The spanner 4 includes an elongated body and an enlarged head defining a star-shaped hole 5. The joint 1 includes a hexagonal section 2 and a square section 3. The hexagonal section 2 is used for engagement with the star-shaped hole 5. The socket 6 defines a square hole 7 at an end and a hexagonal hole at the other end. The square section 3 of the joint 1 is used for insertion in the square hole 7 defined in the socket 6. The hexagonal hole defined in the socket 6 is used for engagement with a hexagonal head of a bolt. The size of the square section 3 of the joint 1 must match that of the square hole 7 defined in the socket 6 so that the joint 1 can positively rotate the socket 6. Depending upon intended strength and size, two series of sockets such as socket 6 are devised. In one series, the sockets include a square hole with a dimension of ½ inch. In the other series, the sockets include a square hole with a dimension of ⅜ inch. Therefore, for engagement with such the two series of sockets, respectively, there must be two joints such as joint 1, one including a square section with a dimension of ½ inch while the other including a square section with a dimension of ⅜ inch. While working, a person often has to select sockets from the two series and is forced to replace a joint of one size with the other joint of the other size. A drawback for using such a conventional socket wrench is that purchasing two joints is not cost effective. A second drawback for using such a conventional socket wrench is the trouble in replacing a joint with the other.

The present invention is therefore intended to obviate or at least alleviate the drawbacks encountered in using conventional socket wrenches.

### SUMMARY OF INVENTION

It is the primary objective of the present invention to provide a socket wrench including a joint capable of engagement with two series of sockets.

To achieve the above-mentioned and other objectives, the present invention provides a socket wrench including a spanner and a joint. The spanner includes an elongated body, an annular head, a driving element received in the annular head and a ratchet mechanism arranged between the annular head and the driving element. Thus, a one-way rotation of the driving element can be selectively provided while the spanner is swayed. The driving element defines a hole. The joint includes a middle section, a first terminal section and a second terminal section including a size different from that of the first terminal section. The middle section is used for insertion in the hole, the first terminal section is used for engagement with a socket of a first series while the second terminal section being used for engagement with a socket of a second series.

### BRIEF DESCRIPTION OF DRAWINGS

FIG. 1 is a perspective view of a socket wrench according to the present invention, showing a spanner disengaged from a joint, while omitting a socket;

FIG. 2 is an enlarged view of a socket wrench as shown in FIG. 1, but showing the spanner engaged with the joint, some portions being broken away for giving details;

FIG. 3 is a side view of a socket wrench as shown in FIG. 2, showing the joint engaged with a socket of a series shown in phantom lines;

FIG. 4 is a side view of a socket wrench as shown in FIG. 2, showing the joint engaged with a socket of a second series shown in phantom lines;

FIG. 5 is a view similar to FIG. 1 but showing a socket wrench according to a second embodiment of the present invention;

FIG. 6 is a view similar to FIG. 2, but showing a socket wrench according to a second embodiment of the present invention; and

FIG. 7 is an exploded view of socket wrench according to prior art.

### DETAILED DESCRIPTION OF PREFERRED EMBODIMENTS

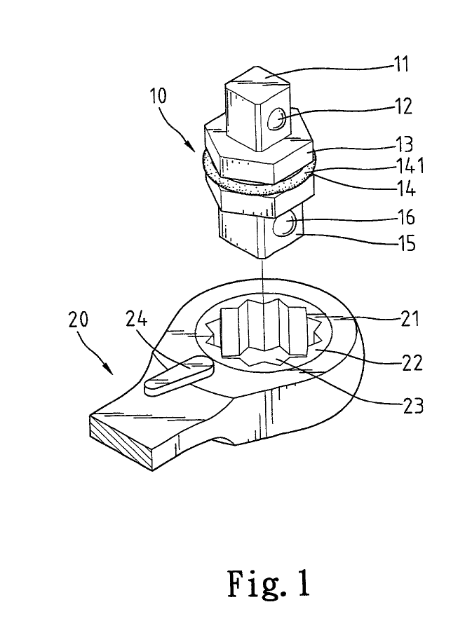

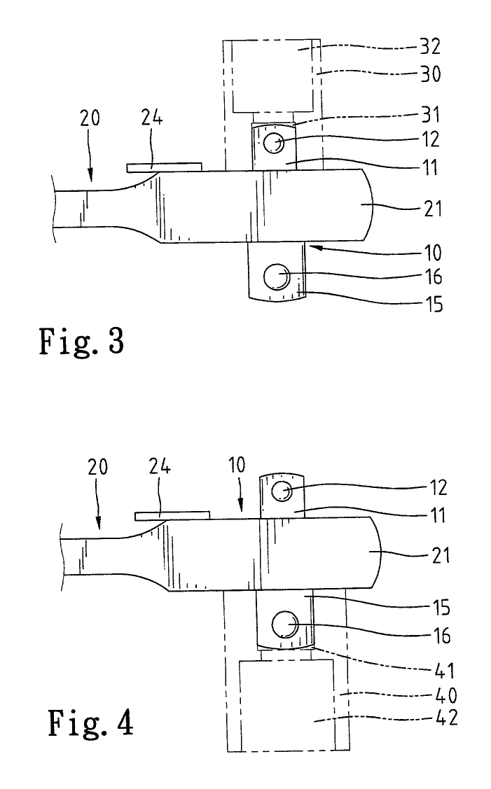

FIG. 1 shows a socket wrench according to a preferred embodiment of the present invention. The socket wrench includes a spanner 20 and a joint 10. The joint 10 is capable of connecting the spanner 20 with a socket shown by means of phantom lines in FIG. 3 and a socket shown by means of phantom lines in FIG. 4.

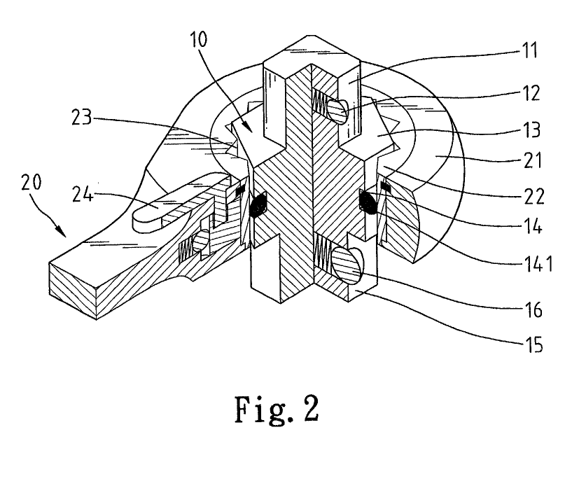

The spanner 20 includes an elongated body (only a portion thereof is shown) and an annular head (not numbered). A driving element 22 is received in the annular head of the spanner 20. As shown in FIG. 2, a ratchet mechanism (not numbered) is arranged between the driving element 22 and the annular head of the spanner 20 in order to selectively provide a one-way rotation of the driving element 22 while the spanner 20 is swayed. The ratchet mechanism includes a switch 24 for selection of the direction in which the spanner 20 drives the driving element 22. The ratchet mechanism is conventional and therefore is not described in detail. The driving element 22 defines a star-shaped hole 23.

The joint 10 includes a hexagonal section 13, a first square section 11 formed at an end of the hexagonal section 13 and a second square section 15 formed at an opposite end of the hexagonal section 13. The hexagonal section 13 can be inserted in the star-shaped hole 23 so that the driving element 22 can drive the joint 10. The hexagonal section 13 defines an annular groove 14 for receiving a ring 141 made of elastic material. As shown in FIG. 2, the ring 141 is used to ensure engagement of the joint 10 with the spanner 20. The first square section 11 includes a position retainer 12. The position retainer 12 is conventional and therefore is not described in detail. The second square section 15 includes a position retainer 16. The position retainer 16 is conventional and therefore is not described in detail. In fact, the square sections 11 and 15 are identical to each other except for difference in size.

Referring to FIG. 3, a socket 30 of a first series is shown in phantom lines. It defines a square hole 31 for receiving the first square section 11 of the joint 10 and a hexagonal hole 32 for receiving a head of a bolt. The square hole 31 includes a size of ½ inch and the first square section 11 of the joint 10 includes a corresponding size so that engagement of them with other can be firm.

Referring to FIG. 4, a socket 40 of a second series is shown in phantom lines. It defines a square hole 41 for receiving the second square section 15 of the joint 10 and a hexagonal hole 42 for receiving a head of a bolt. The square hole 41 includes a size of ⅜ inch and the second square section 15 of the joint 10 includes a corresponding size so that engagement of them with other can be firm.

When a socket of a first series such as the socket 30 is needed, it can be engaged with the first square section 11 of the joint 10. When a socket of second series such as the socket 40 is needed, it can be engaged with the second square section 15 of the joint 10. It is obvious that the joint 10 does not have to be replaced.

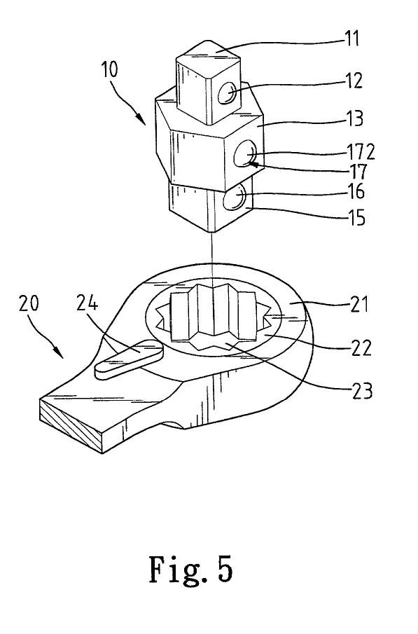

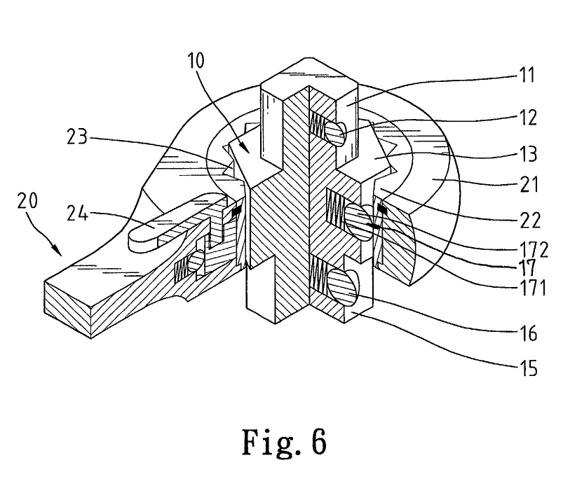

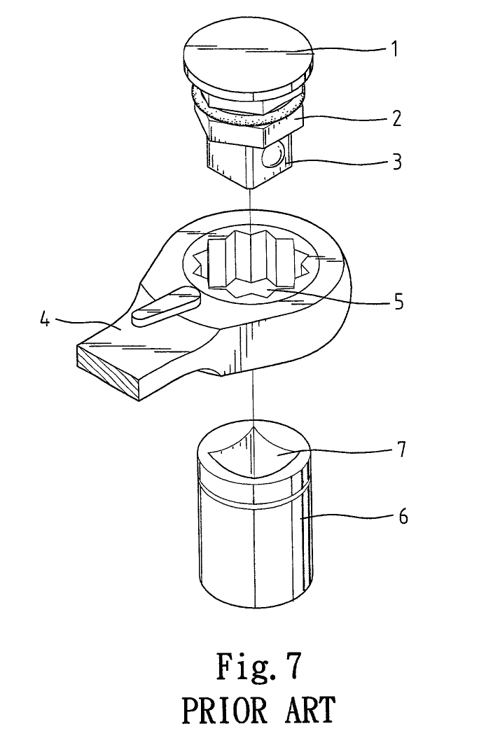

FIGS. 5 and 6 show a socket wrench according to another embodiment of the present invention. The socket wrench shown in FIGS. 5 and 6 is identical to that shown in FIGS. 1 through 4 except for using a position retainer 17 instead of the ring 141. Like the position retainers 12 and 16, the position retainer 17 is conventional and is used to ensure engagement of the joint 10 with the driving element 22. The common structure of the position retainers 12, 16 and 17 is shown in FIG. 6. The position retainer 17 includes a spring 171 and a ball 172. The spring 171 is received in a recess defined in the hexagonal section 13 of the joint 10. The ball 172 is partially received in the recess defined in the hexagonal section 13 of the joint 10 and pressed by means of the spring 171. Thus, the ball 172 can be pressed into the recess defined in the hexagonal section 13 of the joint 10 when the hexagonal section 13 of the joint 10 is inserted in to the star-shaped hole 23. Meanwhile, the ball 172 is pressed against the driving element 22 by means of the spring 171, thus ensuring engagement of the joint 10 with the driving element 22

1. A socket wrench comprising:
a spanner (20) including an elongated body, an annular head, a driving element (22) received in the annular head and a ratchet mechanism arranged between the annular head and the driving element (22) in order to selectively provide a one-way rotation of the driving element (22) while the spanner (20) is swayed, the driving element (22) defining a hole (23);
a joint (10) includes a middle section (13), a first terminal section (11) and a second terminal section (15) including a size different from that of the first terminal section (11), the middle section (13) being used for insertion in the hole (23), the first terminal section (11) being used for engagement with a socket (30) of a first series while the second terminal section being used for engagement with a socket (40) of a second series.

2. The socket wrench as set forth in claim 1 wherein the hole (23) is shaped as a star.

3. The socket wrench as set forth in claim 2 wherein the middle section (13) is shaped as a hexagon.

4. The socket wrench as set forth in claim 1 including a ring (141) attached to the middle section (13) to ensure engagement of the joint (10) with the spanner (20).

5. The socket wrench as set forth in claim 4 wherein the ring (141) is made of an elastic material.

6. The socket wrench as set forth in claim 4 wherein the middle section (13) defines an annular groove (14) for receiving the elastic ring (141).

7. The socket wrench as set forth in claim 1 wherein the middle section (13) includes a position retainer (17) for ensuring engagement of the joint (10) with the driving element (22).

8. The socket wrench as set forth in claim 7 wherein the position retainer (17) includes:
a recess defined in the middle section (13);
a spring (171) received in the recess defined in the middle section (13) of the joint (10); and
a ball (172) partially received in the recess defined in the middle section (13) and pressed by means of the spring (171).

9. The socket wrench as set forth in claim 1 wherein the first terminal section (11) is shaped as a square.

10. The socket wrench as set forth in claim 1 wherein the first terminal section (11) includes a position retainer (12).

11. The socket wrench as set forth in claim 1 wherein the second terminal section (15) is shaped as a square.

12. The socket wrench as set forth in claim 1 wherein the second terminal section (15) includes a position retainer (16).
